(19) United States
(12) Patent Application Publication
(10) Pub. No.: US 2008/0177576 A1
(43) Pub. Date: Jul. 24, 2008

(54) System and method for interactive integration of electronic medical health records

(76) Inventors: Tom Jennings, St. Joseph, MI (US); Jamie Kovach, Saint Joseph, MI (US)

Correspondence Address: Gregory J. Lavorgna, Esquire;Drinker Biddle & Reath LLP, One Logan Square, 18th & Cherry Streets, Philadelphia, PA, 19103, US

(21) Appl. No.: 11/654,986

(22) Filed: Jan. 18, 2007

(51) Int. Cl. G06Q 50/00

(52) U.S. Cl. 705/3

(57) ABSTRACT

The present invention provides a system and method for interactive integration of electronic patient medical records, the system and method having a central personal health record database networked to one or more local medical records maintained by individual health care providers, wherein the central personal health records and the local medical records have compatible electronic data structures, there being a personal health record and at least one local medical record corresponding to each particular patient. Each health care provider may be associated by a particular patient with the personal health record corresponding to the patient, and each health care provider may be enabled to access the personal health record for downloading and synchronization with a corresponding local medical record maintained by the health care provider, and may further be enabled to upload and synchronize changes made in a local medical record back to the corresponding personal health record.

### FIELD OF THE INVENTION

The present invention relates generally to a system and method for the interactive integration of electronic medical health records, and more particularly to a system and method for enabling patients and health care providers to access and update personal health records contained in a central database in coordination with local electronic health records maintained by various health care providers.

### BACKGROUND OF THE INVENTION

It has become common for health care providers to record and maintain patient data in electronic medical records stored by each health care provider with whom a patient may interact for obtaining medical treatment or services. While useful to each particular health care provider who keeps such local electronic medical records for each patient, these records are typically not accessible by either the patient or by other health care providers. Often, a patient may interact with several different health care providers each keeping a local electronic medical record for the patient, the record usually containing some amount of past medical history for the patient as well as a record of interactions between the patient and the health care provider. However, the electronic local medical record maintained by each health care provider may use a different system or method for recording data, including a different data structure, preventing them from being electronically compatible with each other in a way that would enable sharing of medical records electronically between health care providers.

Other systems and methods have been proposed in the prior art to collect various disparate local electronic medical records into a sort of compendium or repository, whereby the records can be accessed electronically by patients and health care providers. However, these systems have merely collected electronic medical records into a centralized place and have not integrated all of the data of the various electronic medical records into personal health records having a common data structure with corresponding local electronic medical records for a particular patient maintained by the patient's health care providers. In particular, as noted above, each electronic medical record may have its own data structure. Absent a system wherein the central personal health record database and the local medical records have the same data structure, systems such as those previously developed would be unable to perform synchronized updates between and among its constituent local electronic medical records. Indeed for such a system to be accessible to the many health care providers using different local electronic medical record data structures, a repository-type system would likely need to resort to an unorganized text-based record. It is readily apparent to a practitioner skilled in the art that such an unorganized free-form text-based system will result in a chaotic and unusable hodge-podge of data when numerous health care providers access and modify the same patient's personal health record in non-standardized and non-uniform manners. Moreover, it would be extremely difficult to conduct analyses, generate reports, perform epidemiological studies, or perform other meaningful manipulation of data stored in such an unorganized system.

The lack of an integrated system capable of coordinating the various electronic local medical records maintained by a patient's various health care providers presents disadvantages. A disadvantage of independent incompatible local medical records is that a patient must repeatedly provide the same data to each new health care provider with regard to the patient's past medical history and sometimes with regard to the history of the present illness a patient is experiencing. Another disadvantage of independent incompatible local medical records is the risk of inconsistencies between records, so that some health care providers may be working with different information than others, thus potentially hampering diagnosis and treatment of the patient. A further disadvantage of independent incompatible local medical records is the inability of a patient to review, verify, and modify his own medical records. A still further disadvantage is the inability to collect the data for a particular patient, or for sets of patients, and analyze the data, generate reports, conduct epidemiological studies, or perform other meaningful manipulation.

Accordingly, it is desirable to have a system and method for integrating electronic local medical records. Additional advantages to be obtained by integrating the numerous independent local medical records will be apparent in view of the following description of the present method and system.

### SUMMARY OF THE INVENTION

The present invention provides a system and method for interactively integrating electronic local medical records respectively maintained by one or more health care provider with a central personal health record that may be accessible to both the patient and his health care provider or providers. The system and method of the present invention provides means to collect and enter a past medical history for a patient, means to translate that past medical history into a personal health record, means for a health care provider to access the personal health record for downloading into a local medical record, means for a health care provider to change and authenticate changes to the local medical record, means for the local medical record to automatically update the personal health record based on changes made to the local medical record, and means for the personal health record to synchronize updated data to all local medical records having access to the personal health record. The system and method of the present invention further provides means for the patient to grant a health care provider full or limited access to the patient's personal health record, means for more than one health care provider to access and interact with the personal health record database concurrently, and means for a patient to terminate, disable, or inactivate full or limited access of a health care provider to the personal health record. The system and method of the present invention still further enables a patient to view and alter the patient's own personal health record. The system and method of the present invention yet further provides a database whereby data may be collected and organized for a particular patient, or for sets of patients, so that the data may be analyzed, reports may be generated, epidemiological studies may be conducted, and other meaningful manipulation may be performed.

### BRIEF DESCRIPTION OF THE DRAWINGS

The accompanying drawings, which are incorporated herein and constitute a part of this specification, illustrated preferred embodiments of the invention, and together with the general description given above and the detailed description given below, serve to explain features of the invention.

FIG. 1 is a schematic showing a situation prior to implementation of the system and method for interactive integration of electronic medical health records of the present invention.

FIG. 2 is a schematic showing an implementation of the system and method for interactive integration of electronic medical health records of the present invention.

FIG. 3 is a schematic showing an overview of the integration of the local medical record maintained by a health care provider with the central personal health record of a patient.

FIG. 4 is a schematic showing a central personal health record containing past medical history of a patient and a local medical record maintained by a health care provider.

FIG. 5 is a schematic showing the integration of a central personal health record into the local medical record maintained by a health care provider.

FIG. 6 is a schematic showing the recordation of present health data by a health care provider, including a history of present illness and review of systems, into a local medical record maintained by the health care provider.

FIG. 7 is a schematic showing the updating of a central personal health record with present health data from a local medical record maintained by a health care provider.

FIG. 8 is a schematic showing the recordation of an encounter report by a health care provider, including a list of problems and diagnoses, into a local medical record maintained by the health care provider.

FIG. 9 is a schematic showing the updating of a central personal health record with an encounter report from a local medical record maintained by a health care provider.

FIG. 10 is a schematic showing the updating of a central personal health record with medical information from multiple health care providers, in conjunction with or separate from other encounters between a patient and the health care providers.

FIG. 11 is a schematic of a network of parties connected to a central personal health record of a patient, wherein an update made from a local medical record maintained by a health care provider is propagated to other parties in the network having a relevant local medical record for the patient.

FIG. 12 is a schematic of a network of parties connected to a central personal health record of a patient, wherein an update made by a patient is propagated to other parties in the network having a relevant local medical record for the patient.

FIG. 13 is a schematic showing a patient adding a health care provider as a subscriber enabled to access the patient's central personal health record.

FIG. 14 is a schematic showing a patient removing or inactivating a health care provider as a subscriber enabled to access the patient's central personal health record.

### DETAILED DESCRIPTION OF PREFERRED EMBODIMENTS

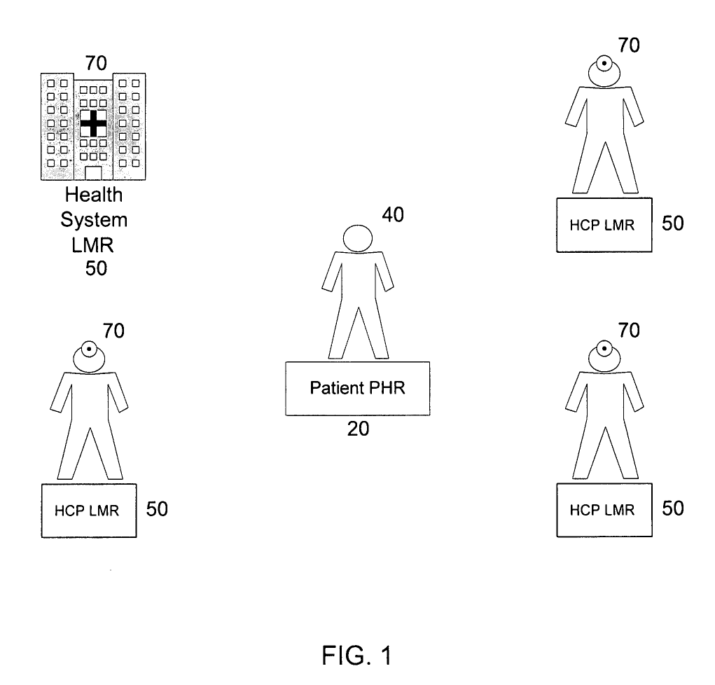

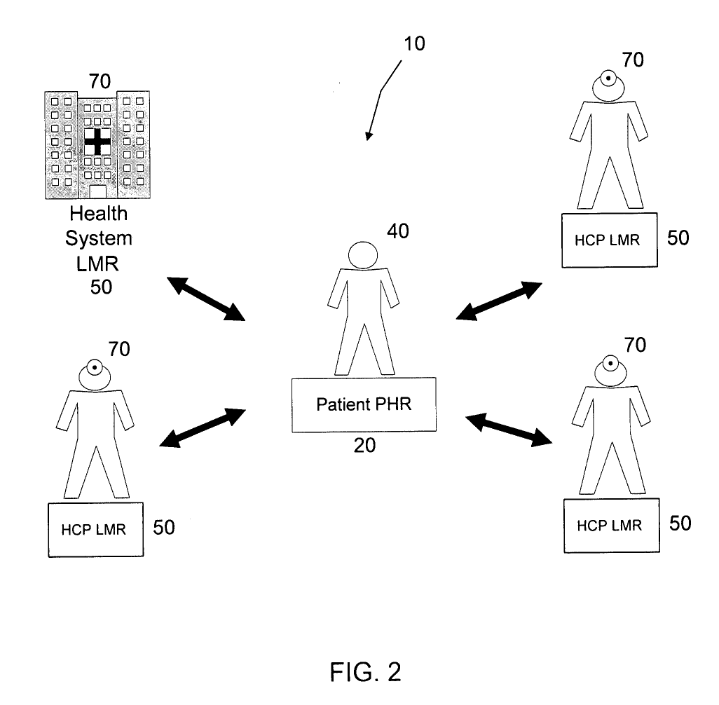

Referring to the figures, where like numerals identify like elements, there is shown in FIGS. 1-2 an overview of a comprehensive system and method provided by an embodiment of the present invention for integrating formerly separately maintained local medical records 50 for a particular patient 40 into a networked database 100 of personal health records 20, whereby changes to a local medical record 50 maintained by each health care provider 70 on the network, as well as changes to a past medical history 25 maintained by a patient 40, can be updated into a central personal health record 20 that is accessible to all parties having access to the network. In the present system 10, a centralized personal health record 20 and a multitude of local medical records 50 utilize the same data structure and content so that they interact seamlessly. Accordingly, when one local medical record 50 for a patient 40 is modified by one health care provider 70, the centralized personal health record 20 for the patient 40, and all other local medical records 50 for the patient 40 that are interconnected to the database 100 within the system 10, are synchronized and updated to have the most current medical data about the patient 40.

For ease and clarity of description, the following terms are ascribed the following meanings as used herein, it being recognized that other terms may interchangeably be used without deviating from the letter and spirit of the present invention. The abbreviations enclosed in parenthesis are used in conjunction with the appended figures. A “patient” 40 is any person seeking treatment or other services from a health care provider 70. A “health care provider” (HCP) 70 may be any medical professional with whom a patient 40 might interact or obtain treatment or services, including but not limited to a physician, an dentist, a pharmacist, a specialist, a psychiatrist, a hospital, and an emergency clinic. A “personal health record” (PHR) 20 is an electronic health record for a particular patient 40, including a past medical history 25 and current medical data with regard to that patient 40. The personal health record 20 may also include a chart portion 30 capable of storing text records documenting particular encounters between a patient 40 and a health care provider 70. A “history of present illness and review of systems” is an electronic health record of the background, symptoms, and other relevant data regarding the present illness for which a patient 40 is currently being treated or served by a health care provider 70. An “encounter report” 60 is an electronic health record memorializing an encounter between a health care provider 70 and a patient 40 occurring in the immediate past with regard to a present illness for which a patient 40 is currently being treated or served. A “past medical history” (PMH) 25 is an electronic health record for a particular patient 40 that includes past medical data, i.e., all of the data in the personal health record 20 except for a history of present illness, a review of systems, and an encounter report 60 pertaining to an encounter between a patient 40 and a health care provider 70 occurring in the immediate past. A “local medical record” (LMR) 50 is an electronic health record maintained by a health care provider 70, containing any history of present illness, review of systems, and encounter reports 60 that have been generated by that health care provider 70 resulting from previous or current encounters between the patient 40 and the health care provider 70. A local medical record 50 may also include some amount of past medical history data 25 that may have been collected and recorded by the health care provider 70. A local medical record 50 is stored on an local electronic device controlled by the health care provider 70. The local electronic device may be a computer, a computer terminal, or any wired or wireless device having a processor and a memory, the local electronic device being capable of accessing the personal health record database 100 for the purpose of receiving data from and sending data to the personal health record database 100, the local electronic device further being capable of altering and saving an altered version of the local medical record 50 into a corresponding personal health record 20 for a particular patient 40.

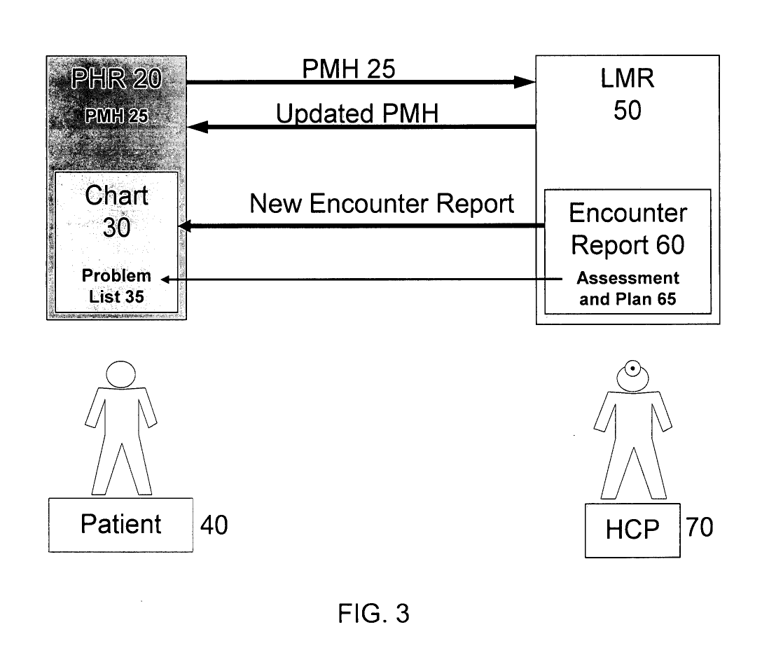

With reference to FIGS. 3-10, the system and method of the present invention provides for the interactive electronic integration of personal health records 20 and local medical records 50. As shown generally in the figures, a personal health record 20 for a particular patient 40 resides in a central electronic database 100. Prior to an encounter between a patient 40 and a health care provider 70, the personal health record 20 contains the past medical history 25 of the patient 40. In the system and method of the present invention, the personal health record 20 is transformed into a central personal health record 20 capable of unifying, coordinating, and updating the various separate local medical records 50 that are maintained and updated independently by various health care providers 70 with whom the patient 40 may from time to time interact for obtaining treatment or services.

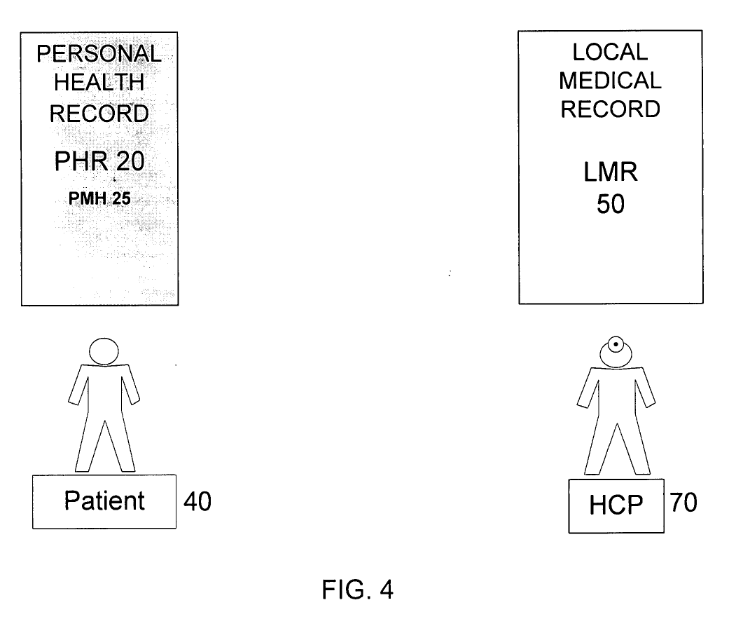

The past medical history 25 contains data that may include, but is not limited to, information pertaining to diseases, medications, allergies, surgeries, and immunizations of the patient 40. The past medical history 25 may be generated in numerous ways, as shown generally with reference to FIG. 4. In one example, a patient 40 may generate the past medical history 25 by answering a paper questionnaire and having the answers to that questionnaire later input into electronic record format. In another example, a patient 40 may be interviewed by a health care provider 70, so that the health care provider 70 may ask follow-up questions tailored to various responses by the patient 40 and based on a record of previous encounters, in order to produce a more comprehensive record, and the results of the interview concurrently, or subsequently, input into electronic record format. In yet another example, a patient 40 may complete an adaptive electronic questionnaire programmed to intelligently ask follow-up questions tailored to various responses by the patient 40 in a similar manner to the health care provider interview, the electronic questionnaire automatically generating an electronic record.

Regardless which way the electronic past medical history 25 is initially generated, the past medical history 25 in the personal health record 20 forms the foundation for integrating the local medical records 50 maintained by various health care providers 70 with whom a patient 40 may interact. Once the past medical history 25 is generated and incorporated into the personal health record 20, the data in the past medical history 25 is accessible to the patient 40 and to any health care provider 70 with whom the patient 40 may interact and to whom the patient 40 has granted access, so that the process of generating the past medical history 25 need not be repeated from scratch for each new health care provider 70 or for subsequent visits to the same health care provider 70.

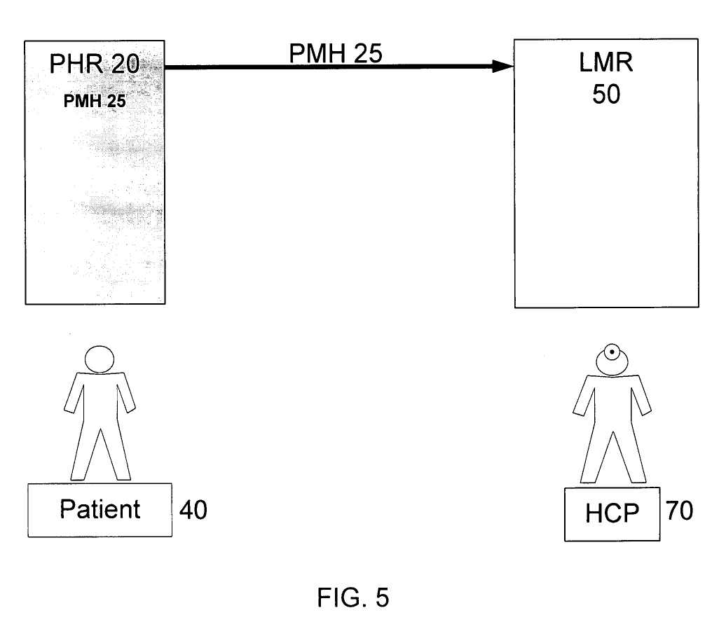

With reference to FIG. 5, once a patient 40 has a personal health record 20, the patient 40 can grant or enable a health care provider 70 access to the personal health record 20. Access can be granted by way of a passphrase or other means known in the art. In most cases the patient 40 may elect to grant full read-write access to a health care provider 70, to permit the health care provider 70 to inspect, download, edit, update, or otherwise alter or modify, the personal health record 20; in some cases the patient 40 may elect to grant only read access to permit the health care provider 70 only to inspect the personal health record 20 or to download the personal health record 20 for local use and modification as a local medical record 50.

When a patient 40 with a personal health record 20 is seen by a health care provider 70, the data from the personal health record 20 is transferred to the health care provider's local medical record 50 and becomes the past medical history 25 for that patient 40 for the purposes of the present encounter. As a result, the health care provider 70 need only ask the patient 40 about the patient's history of present illness and review of systems, significantly streamlining the encounter and saving time for both the patient 40 and the health care provider 70. In an example, if the patient 40 has been previously seen with regard to the same present illness, the patient's past medical history 25 is updated in the personal health record 20 and new data may be highlighted so that the health care provider 70 can readily see what changes have been made to the patient's past medical history 25.

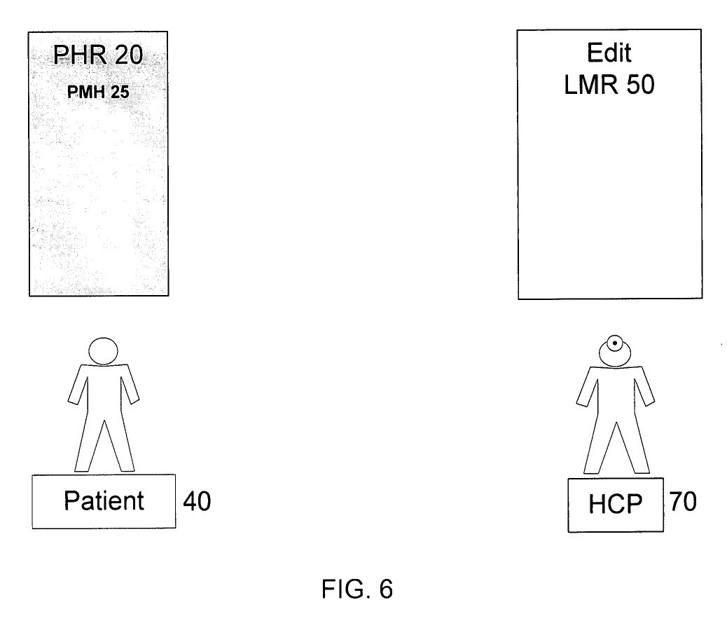

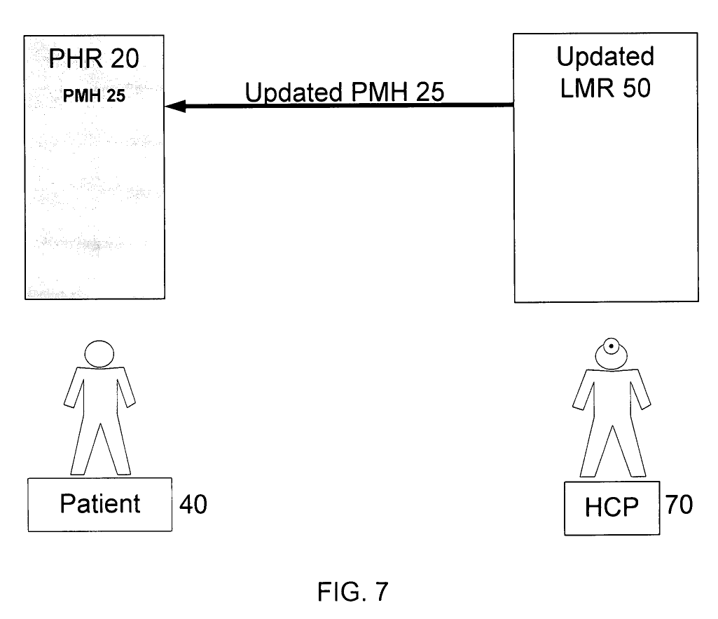

At the conclusion of an encounter between the patient 40 and a health care provider 70, several actions may occur. As shown in FIG. 6, the health care provider 70 may update the local medical record 50 that had previously been downloaded from the central personal health record 20. Changes to a local medical record 50 are preferably required to be electronically signed to verify the authenticity of the health care provider 70 making changes to the local medical record 50. Authentication is also a preferable means by which one health care provider 70 is prevented from altering data in the personal health record 20 of a patient 40 that was previously entered by another health care provider 70. As shown in FIG. 7, any changes made to the patient's local medical record 50 are updated back into the central personal health record 20, integrating the data generated by the office visit, including the history of present illness and review of systems, into the personal health record 20.

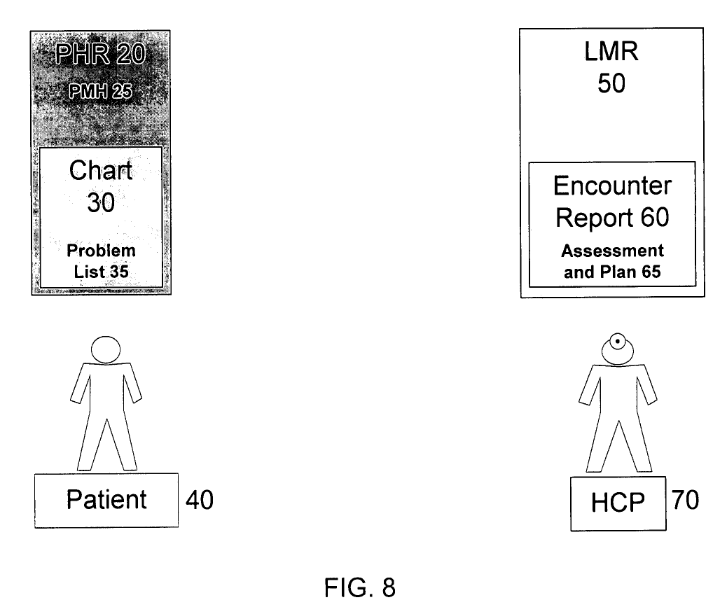

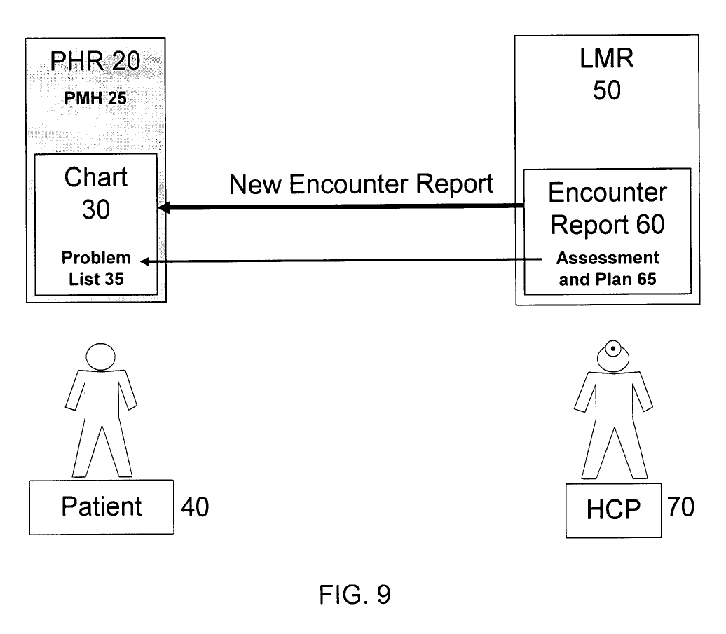

As shown in FIG. 8, the health care provider 70 may generate an encounter report 60 summarizing the patient visit. As shown in FIG. 9, the encounter report 60 may be transmitted to the central personal health record 20 to be stored in a chart portion 30 of the personal health record 20. For any health care provider 70, the patient 40 may selectively enable access to the chart portion 30 of the personal health record 20 separately from access to the remainder of the central personal health record 20.

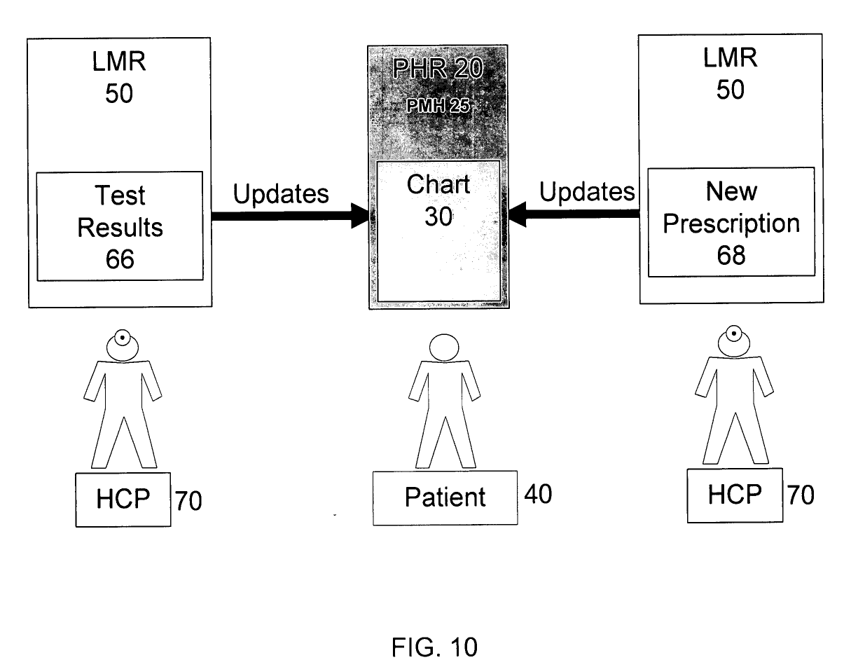

As illustrated generally in FIG. 10, a health care provider 70 may also access and modify a patient's personal health record 20 between patient-provider encounters, or based on an event other than a patient-provider encounter. As non-limiting examples, a physician 70 may add the results of a medical test 66 to the personal health record 20, or a pharmacist 70 may add records of the filling of a new prescription 68 to the personal health record 20, or the patient 40 may add newly learned medical history data to the personal health record 20.

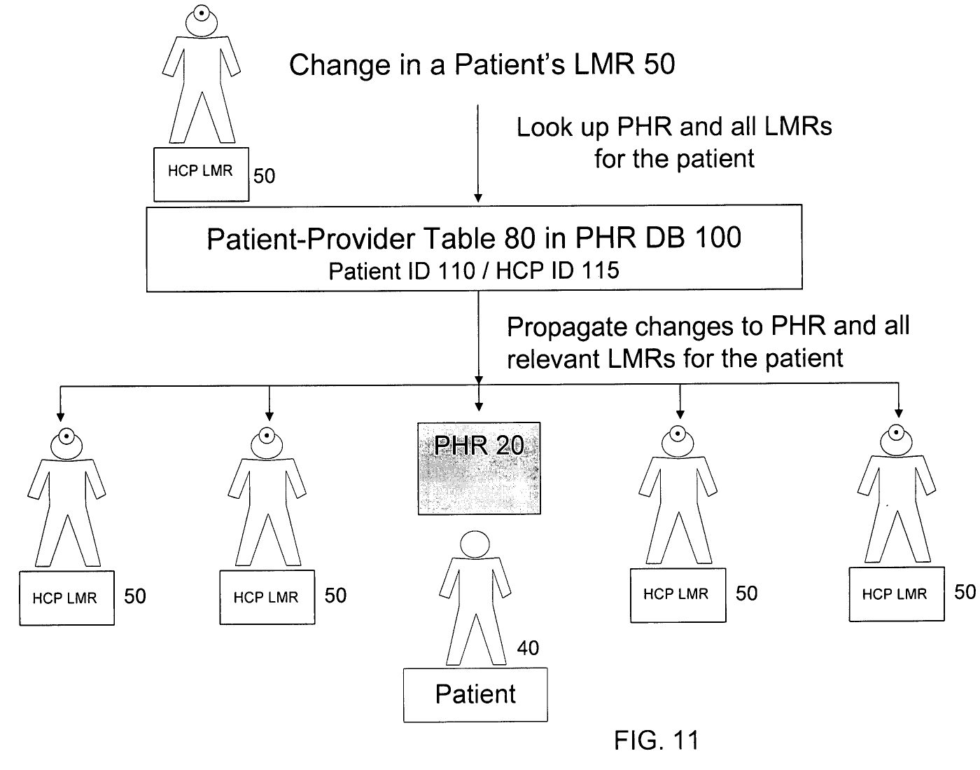

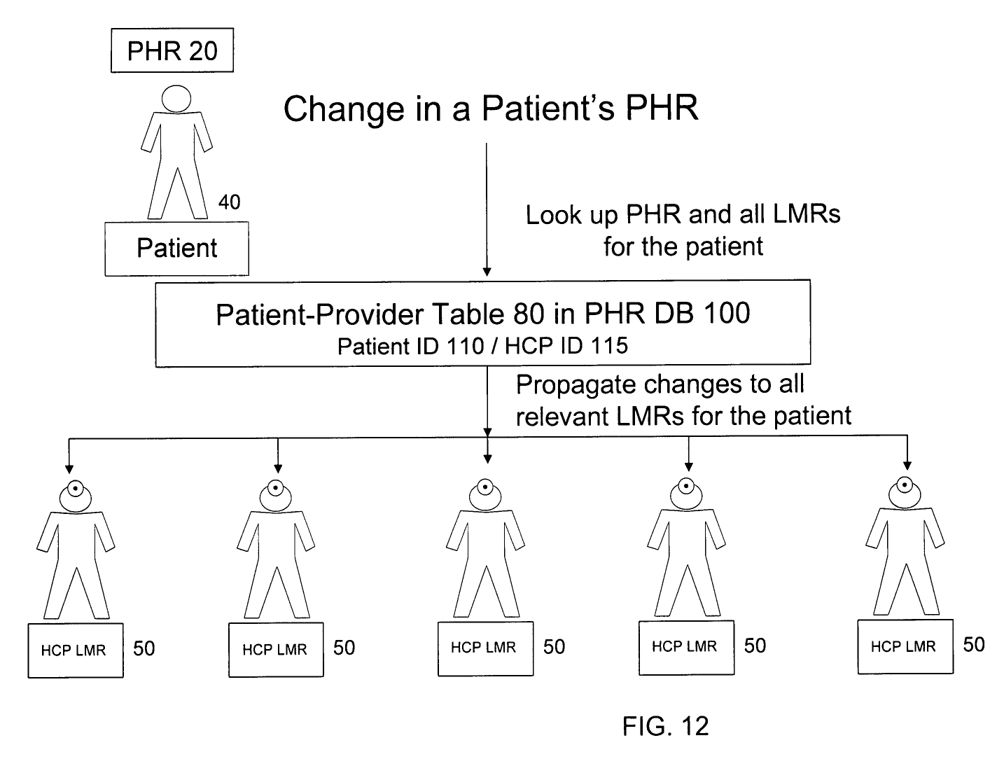

As illustrated in FIGS. 11-12, a typical patient 40 interacts with numerous health care providers 70 who may require access to the patient's personal health record 20 and who may each maintain a local medical record 50 on that patient 40. It is therefore apparent that the central personal health record 20 serves as a coordinating system and database 100 by which each health care provider 70 both may access a patient's personal health record 20 so as to have the most current local medical record 50 and may update a patient's personal health record 20 with data newly added to or changed in a local medical record 50. A network of health care providers 70 is created whereby the central personal health record database 100 is a hub through which each of the local medical records 50 exchanges data, the hub also maintaining the most current personal health record 20 for each patient 40 to be accessed and updated by each of the authenticated health care provider local medical records 50 which function as nodes on the network.

In the present method and system 10 of integrating electronic medical health records, a patient 40 may access and edit the data in his own personal health record 20 using a patient electronic device, as shown in FIG. 12. Any changes made by the patient 40 to the central personal health record 20 are propagated to each relevant local medical record 50 for that patient 40 on the network. A health care provider 70 may also access and edit the data in the personal health record 20, as shown in FIG. 11, by the indirect means of modifying the health care provider's local medical record 50 for a particular patient 40. To access and edit the personal health record 20, a health care provider 70 would download the most current personal health record 20 for that patient 40 (including the most current past medical history 25) into the health care provider's local medical record 50 for that patient 40, make modifications as required to the patient's local medical record 50, and update the modified local medical record 50 into the central personal health record 20. The updated personal health record 20 is then propagated to each relevant local medical record 50 on the network for the particular patient 40. A local medical record 50 maintained by a health care provider 70 on the network may be deemed relevant if it relates to a particular patient 40 and that particular patient 40 has granted access to enable a particular health care provider 70 to access the patient's personal health record 20.

In particular, when a health care provider 70 adds data to a patient's local medical record 50 the following sequence occurs. In one step, the health care provider 70 opens a patient's local medical record 50, makes any additions or changes that may be deemed necessary, and electronically signs the local medical record 50. In a next step, the electronic local medical record 50 recognizes that changes have been made and looks up the patient's personal health record 20 in the central personal health record database 100. The local medical record 50 uploads any changes to the central personal health record 20. In a next step, the central personal health record 20 recognizes that changes have been made and looks up any other health care provider local medical records 50 for the patient 40. In a next step, the central personal health record 20 transmits and loads any additions and changes from the personal health record 20 to all relevant health care provider local medical records 50 containing the patient 40. Thus, the method of the present invention integrates all local medical records 50 with the central personal health record 20 for every patient 40, so that the result of the foregoing steps is to create an integrated system 10 of personal health record 20 and local medical record 50 databases 100 having the same most current data about a particular patient 40.

Advantages of the method and system of the present invention accrue to various parties associated with or involved in the health care of patients, including but not limited to patients, health care providers, health care organizations, and insurance companies. The method and system of the present invention provides a health care provider 70 with the most up-to-date past medical history 25 of a patient 40 with virtually no effort, because changes to the central personal health record 20 of a patient 40 are automatically updated from the local medical record 50 of any health care provider 70 whenever changes are made to the patient's local medical record 50, and then changes to the central personal health record 20 are automatically updated into each local medical record 50 at any other health care provider 70 having access to the personal health record 20 for the patient 40. This eliminates the need for a first health care provider 70 to continually and manually update a patient's local medical record 50 to incorporate changes that may have been made by other health care providers 70 since the most recent previous encounter between the patient 40 and the first health care provider 70.

In the method and system of the present invention, the data structure of the patient's personal health record 20 and local medical records 50 correspond to each other, that data structure being preserved regardless who modifies the records or how many times they are modified. In an embodiment of the present invention, the data structure of a personal health record 20 for a particular patient 40 is derived from the data structure of a corresponding local medical record 70 for that patient 40. The uniformity of data structure eases management of the patient's data and enables coherent analysis of the data, generation of reports, epidemiological studies, and any other manipulation of the data for diagnostic, scientific, or research purposes.

To implement the method and system 10 of integrating the personal health record 20 and local medical records 70, the personal health record database 100 contains a unique patient record number (“Patient ID”) 110 assigned to each patient 40 through which each patient's personal health record 20 is accessed. The patient record number 110 is associated with both the personal health record 20 and the basic demographic data, such as name, address, and phone number, for each patient 40. A unique health care provider number (“HCP ID”) 115 is assigned to any health care provider 70 enabled to access one or more patient health records 20 within the database 100. The personal health record database 100 contains a patient-provider table 80 correlating the unique patient record number 110 with the unique identifier numbers 115 assigned to each health care provider 70 so that all of the local medical records 50 associated with each patient 40 can readily be identified. Accordingly, when an addition or change is made to a patient's local medical record 50, the associated health care provider's local medical record 50 updates the personal health record 20 and then accesses the patient-provider table 80 to identify and update all other health care provider local medical records 50 associated with that patient 40.

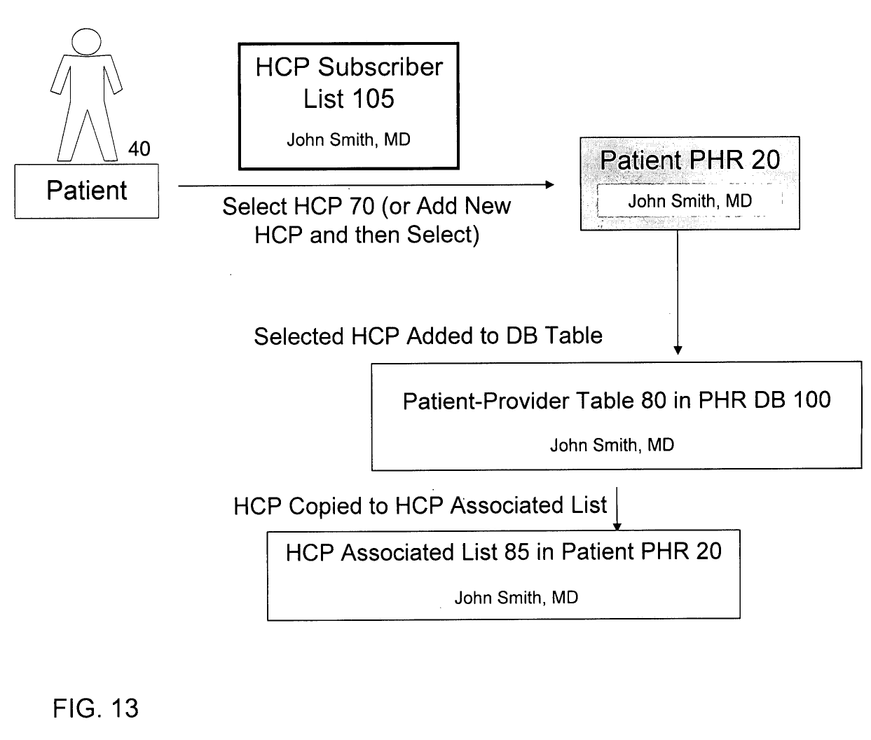

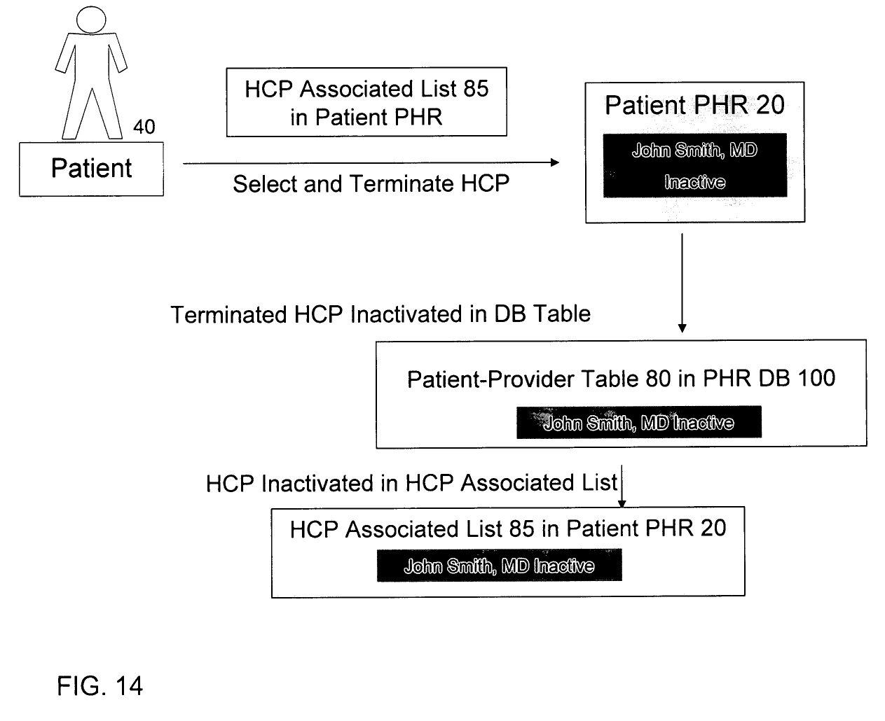

With reference to FIGS. 13-14, any health care provider 70 may be associated with or disassociated from the personal health record 20 of any patient 40. In other words, a patient 40 may grant access or cancel or inactivate previously granted access with regard to any health care provider 70. A list 85 containing each health care provider 70 associated with the patient 40 is stored in the central personal health record database 100 in coordination with the patient-provider table 80. The patient 40 has control of the patient's own list 85, and may add a health care provider 70 to the list 85 granting full access, may add a health care provider 70 to the list 85 granting partial (read-only) access, or may remove a health care provider 70 from the list 85 to whom access had previously been granted. If desired, when adding a particular health care provider 70 to the list 85, the patient 40 can specify whether access is also permitted by associates of the health care provider 70 who may be part of the same medical practice, or whether access will be restricted to only that health care provider 70. Access may be granted to any health care provider 70 for an unspecified amount of time or for a limited duration (e.g., for the time period of a specific course of treatment with that health care provider 70), at the discretion of the patient 40.

The level of access a patient 40 may grant to a health care provider 70 may also depend on whether the health care provider 70 has a compatible local medical record 50 that is capable of interacting with the central personal health records 20 in the personal health record database 100 such that the health care provider 70 is capable of being part of the networked system 10. When the health care provider 70 has a compatible local medical record 50, the health care provider's identity is stored in a health care provider subscriber list 105 in the personal health record database 100. The patient 40 can select that health care provider 70 and the unique health care provider identifier number 115 will be added to the patient's patient-provider table 80 and associated list 85. When the health care provider 70 does not have a compatible local medical record 50 that is capable of interacting with the central personal health records 20 in the personal health record database 100, the patient 40 will be limited to granting that health care provider 70 read-only access.

Access to a personal health record 20 by a health care provider 70 can be terminated by either the patient 40 or the health care provider 70. When a patient 40 ends a patient-provider relationship and terminates access (i.e., the health care provider 70 is removed from the patient's patient-provider table 80 and associated list 85, or is retained in an inactive status), the health care provider's local medical record 50 will no longer be able to interact with the central personal health record 20. When a patient 40 decides to terminate access to the patient's personal health record 20 by a health care provider 70, the patient 40 may specify the termination to occur at some future date to permit the patient 40 time to obtain and grant access to a new health care provider 70. Similarly, when a health care provider 70 ends a patient-provider relationship, the health care provider 70 is removed from the patient's patient-provider table 80 and associated list 85, and the health care provider's access to the personal health record 20 is terminated. When a health care provider 70 decides to terminate a patient-provider relationship, the health care provider 70 may specify the termination to occur at some future date to permit the patient 40 time to obtain and grant access to a new health care provider 70.

It is anticipated that there may be instances where multiple health care providers 70 may need to access or update the same personal health record 20 at the same time. Various methods are known in the art for record notification, locking, and synchronization, and any of these may be employed in the present system and method 10. In one example, only one health care provider 70 may have full access to the personal health record 20 in the database 100 at a time, and as long as the first health care provider 70 is accessing the personal health record 20 of a patient 40, any subsequently accessing health care provider 70 will have read-only access. In another example, when one health care provider 70 is working on a personal health record 20 and another health care provider 70 seeks to access that personal health record 20, both are permitted access and both health care providers 70 are notified of the other's access. In yet another example, when one health care provider 70 electronically signs its local medical record 50 so as to signal the personal health record database 100 to perform an update of the personal health record 20 and all local medical records 50 associated with the particular patient 40, another health care provider 70 concurrently accessing the same personal health record 20 receives a notification that alterations to the personal health record 20 have been made and the alterations may be called to the attention of that other health care provider 70.

There are numerous ways by which the central personal health record 20 may be accessed by a patient 40 and by health care providers 70. In one embodiment, the personal health record 20 may be stored on a central server accessible by a public electronic information system such as the Internet, whereby the personal health record 20 may be accessed from any web-enabled electronic device. As described above, different levels of passcode access can be established for each health care provider 70 and for each personal health record 20. In another embodiment, the personal health record 20 may be stored on a portable medium such as a flash-drive or a writable optical disc and carried with the patient 40 to each health care provider 70.

In another embodiment, the system and method of the present invention comprises a central computer server and at least one health care provider local electronic device. The central computer server stores the database 100 of personal health records 20 in a memory or on a computer usable medium, which may include but is not limited to a hard disk drive, a magnetic tape drive, or a flash drive. The health care provider local electronic device stores at least one local medical record 50 for a patient 40 to whose personal health record 20 the health care provider 70 has access in a memory or on a computer usable medium, which may include but is not limited to a hard disk, a magnetic tape drive, or a flash drive. The central computer server and local electronic device are capable of connecting to each other via an electronic information system or network, whether wired or wireless, to provide for the exchange of electronic data between the central computer server and the local electronic device.

The computer usable medium of the central computer server further stores computer program code that causes the computer server to perform the functions of the present system and method 10, including storing the personal health records database 100, enabling a patient 40 to grant or terminate access to his personal health record 20 by a health care provider 70, locating and synchronizing the personal health record 20 for each patient 40 with relevant corresponding local medical records 50 maintained by the one or more health care providers 70 with whom a particular patient 40 interacts and to whom a particular patient 40 has granted appropriate access, maintaining a patient-provider table 80 and associated list 85 corresponding with the personal health record 20 for each patient 40 that is identified by a unique patient record number 110, and maintaining a health care provider subscriber list 105 having a unique health care provider identifier number 115 corresponding to each health care provider 70 permitted access to one or more patient personal health records 20 stored in the database 100.

The computer usable medium of the health care provider local electronic device further stores computer program code that causes the local electronic device to perform the functions of the present system and method 10, including storing one or more local medical records 50, accessing personal health records 20 stored in the central server database 100 to which health care provider local electronic device has been granted access, retrieving data from a personal health record 20 stored on the central server, modifying a local medical record 50, transmitting a modified local medical record 50 to update the personal health record 20 stored on the central server, creating an encounter report 60, uploading an encounter report 60 into the chart portion 30 of a personal health record 20, and providing means to authenticate a health care provider 70 using the local electronic device.

Other embodiments, now known or to be developed in the future, may be equivalently used to implement the system and method of the present invention for interactively integrating a central personal health record 20 and local medical records 50 maintained by one or more individual health care providers 70.

While the invention has been disclosed with reference to certain preferred embodiments, numerous modifications, alterations, and changes to the described embodiments are possible without departing from the sphere and scope of the invention, as defined in the appended claims and equivalents thereof. Accordingly, it is intended that the invention not be limited to the described embodiments, but that it have the full scope defined by the language of the following claims.

What is claimed is:

1. An electronic medical records integration system comprising:
a medical information database connected to a network, the medical information database containing at least one patient health record having a data structure, each patient health record respectively corresponding to a particular patient, each patient health record including past medical history data;
one or more local electronic devices capable of connecting to the network, each local electronic device containing at least one local medical record having a data structure compatible with the data structure of the at least one patient health record contained in the medical information database, each local medical record corresponding to a particular patient, wherein:
each patient health record is associated with one or more health care providers;
each health care provider has a local electronic device, each patient health record contained in the medical information database thereby being associated with one or more corresponding local medical records contained in one or more local electronic devices;
at least one health care provider using a local electronic device is enabled to access the patient health record corresponding to a particular patient with which the health care provider is associated in order to download past medical history data from the patient health record into a corresponding local medical record;
at least one health care provider using a local electronic device is enabled to alter a local medical record corresponding to a particular patient with which the health care provider is associated; and
at least one health care provider using a local electronic device is enabled to access the patient health record corresponding to a particular patient with which the health care provider is associated in order to upload changes from a local medical record into the corresponding patient health record.

2. An electronic medical records integration system according to claim 1, wherein a patient using a patient electronic device capable of connecting to the network is able to inspect and alter the patient health record corresponding to the patient in the medical information database.

3. An electronic medical records integration system according to claim 1, wherein a patient using a patient electronic device capable of connecting to the network is able to perform one or more of the following actions:
associating a health care provider with the patient health record corresponding to the patient in the medical information database;
granting access to a health care provider using a local electronic device to read data from and write data to the patient health record corresponding to the patient;
granting access to a health care provider using a local electronic device to only read data from the patient health record corresponding to the patient; and
terminating access that had been previously granted to a health care provider to read data from and/or to write data to the patient health record corresponding to the patient.

4. An electronic medical records integration system according to claim 1, wherein a health care provider using a local electronic device is enabled to add text-based data including encounter reports to the patient health record corresponding to a particular patient with which the health care provider is associated.

5. An electronic medical records integration system according to claim 1, further comprising synchronization of the personal health record with any local medical records corresponding to a particular patient, wherein:
each local electronic device is adapted to automatically upload changes from a local medical record into the corresponding patient health record;
the medical information database is adapted to recognize when changes are uploaded into a particular patient health record;
the medical information database is adapted to locate any local medical records contained in the local electronic devices connected to the network corresponding to the particular patient health record into which changes are uploaded; and
the medical information database is adapted to automatically download the changes from the particular patient health record into which changes are uploaded into any corresponding local medical records.

6. An electronic medical records integration system according to claim 1, wherein the network is the Internet and the local electronic device is any electronic device for accessing the Internet.

7. An electronic medical records integration system according to claim 1, wherein a portion of the past medical history data is generated by an interactive electronic interview completed by the patient.

8. An electronic medical records integration system according to claim 1, wherein a portion of the past medical history data is generated by data entered by a health care provider subsequent to an in-person interview of the patient by the health care provider.

9. An electronic medical records integration system according to claim 1, wherein a portion of the past medical history data is generated based upon a paper record including patient medical data.

10. A method for creating an integrated electronic system of patient health records comprising:
generating at least one patient health record including past medical history data, each patient health record respectively corresponding to a particular patient, each patient record having a data structure;
storing the at least one patient health record in a medical information database connected to a network;
providing one or more local electronic devices capable of connecting to the network, each local electronic device further being capable of storing at least one local medical record having a data structure compatible with the data structure of the at least one patient health record stored in the medical information database;
associating one or more health care providers with each patient health record, each associated health care provider having a local electronic device;
enabling at least one health care provider using a local electronic device to access the patient health record in the medical information database corresponding to a particular patient with which the health care provider is associated in order to download past medical history data from the patient health record into a corresponding local medical record;
enabling at least one health care provider using a local electronic device to alter a local medical record corresponding to a particular patient with which the health care provider is associated;
enabling at least one health care provider using a local electronic device to access the patient health record in the medical information database corresponding to a particular patient with which the health care provider is associated in order to upload an altered local medical record into the corresponding patient health record.

11. A method for creating an integrated electronic system of patient health records according to claim 10, further comprising enabling a patient to inspect and alter the patient health record corresponding to the patient in the medical information database.

12. A method for creating an integrated electronic system of patient health records according to claim 10, further comprising enabling a patient perform one or more of the following actions:
associating a health care provider with the patient health record corresponding to the patient in the medical information database;
granting access to a health care provider to read and write data into the patient health record corresponding to the patient;
granting access to a health care provider to only read data from the patient health record corresponding to the patient;
terminating access that had previously been granted to a health care provider to read data from and/or to write data to the patient health record corresponding to the patient.

13. A method for creating an integrated electronic system of patient health records according to claim 10, further comprising enabling a health care provider using a local electronic device to add text-based data including encounter reports to the patient health record corresponding to a particular patient with which the health care provider is associated.

14. A method for creating an integrated electronic system of patient health records according to claim 10, further comprising synchronizing the personal health record with any local medical records corresponding to a particular patient, wherein:
each local electronic device connected to the network automatically uploads changes from a local medical record into the corresponding patient health record;
the medical information database recognizes when changes are uploaded into a particular patient health record;
the medical information database locates any local medical records contained in the local electronic devices connected to the network corresponding to the particular patient health record into which changes are uploaded; and
the medical information database automatically downloads the changes from the particular patient health record into which changes are uploaded to any corresponding local medical records contained in the local electronic devices connected to the network.

15. A method for creating an integrated electronic system of patient health records according to claim 10, wherein the network is the Internet and the local electronic device is any electronic device for accessing the Internet.

16. A method for creating an integrated electronic system of patient health records according to claim 10, further comprising generating a portion of the past medical history data by an interactive electronic interview completed by a patient.

17. A computer program product comprising:
a first computer usable medium having a first computer readable program code means embodied therein, the first computer readable program code means causing a first computer to store in memory a medical information database comprising one or more patient health records each corresponding to a particular patient, a list having one or more health care providers, and unique patient-provider identification means for associating one or more health care providers with one or more respective patient health records, wherein each patient health record has a data structure, wherein each patient health record includes past medical history data;
at least one second computer usable medium having a second computer readable program code means embodied therein, the second computer readable program code means causing a second computer to store in memory at least one local medical record corresponding to a particular patient having unique patient identification means for enabling each local medical record to be associated with a corresponding patient health record in the medical information database, the second computer usable medium being in electronic data exchange relationship with the first computer usable medium, wherein each local medical record has a data structure compatible with the data structure of the corresponding patient health record; whereby:
the first computer readable program code provides a patient means to enable a health care provider to access the patient health record corresponding to the patient, the first computer readable program code means further providing means for the patient to disable a health care provider from accessing the patient health record corresponding to the patient; and
the second computer readable program code means provides a health care provider means to access one or more patient health records with which the health care provider is associated, the second computer readable program code means further providing means for a health care provider to download data from a patient health record stored on the first computer to a corresponding local medical record stored on the second computer, means for a health care provider to alter a local medical record stored on the second computer, and means for a health care provider to upload changes from a local medical record stored on the second computer into the corresponding patient health record stored on the first computer.

18. The computer program product according to claim 17, wherein the first computer readable code means further provides a patient means to alter the patient medical history in the patient health record corresponding to the patient.

19. The computer program product according to claim 17, wherein the second computer readable code means further provides means to authenticate alterations made by a health care provider to a local medical record and means to automatically upload data from a local medical record to which alterations have been made to the corresponding patient health record stored on the first computer.

20. The computer program product according to claim 17, wherein the first computer readable code means further provides means to recognize when alterations to the patient health record corresponding to a particular patient have be made, means to identify any corresponding relevant local medical records for the particular patient stored on one or more second computers, and means to automatically download data from the personal health record to which alterations have been made to any corresponding relevant local medical records stored on one or more second computers.
